(19) United States
(12) Patent Application Publication
(10) Pub. No.: US 2026/0093054 A1
(43) Pub. Date: Apr. 2, 2026

(54) SYSTEMS AND METHODS FOR ASSESSING RESOURCE AVAILABILITY AND UNCERTAINTY IN A SUBSURFACE REGION

(71) Applicant: Chevron U.S.A. Inc., San Ramon, CA (US)

(72) Inventors: Jianchang Liu, Katy, TX (US); Fang Lin, Sugar Land, TX (US); Yushi Zhao, Missouri City, CA (US)

(21) Appl. No.: 18/902,631

(22) Filed: Sep. 30, 2024

(51) Int. Cl. G01V 20/00

(52) U.S. Cl. CPC G01V 20/00

(57) ABSTRACT

A subsurface region is divided into multiple domains based on criteria defined to better represent the input data and uncertainty distribution. Resource availability is simulated independently at the domain scale and then combined to assess the overall resource availability and uncertainty from the entire subsurface region. The overall resource availability and uncertainty are used to facilitate resource recovery from the subsurface region.

### FIELD

The present disclosure relates generally to the field of assessing resource availability and uncertainty in subsurface regions.

### BACKGROUND

Deterministic approaches for resource estimation fail to cover variations of resource availability and uncertainty associated with resource availability. Simple stochastic approaches for resource estimation fail to provide realistic resource availability and uncertainty for a subsurface region due to complexity of subsurface properties in the subsurface region.

### SUMMARY

This disclosure relates to subsurface resource assessment. Subsurface property information and/or other information may be obtained. The subsurface property information may characterize values of subsurface properties in a subsurface region as a function of location within the subsurface region. The subsurface region may be divided into domains based on distributions of the values of the subsurface properties in the domains. Simulation of resource availability and uncertainty from the domains may be performed separately to determine simulated resource availability and uncertainty from individual domains. Total simulated resource availability and uncertainty from the subsurface region may be determined based on combination of the simulated resource availability and uncertainty from individual domains. Resource recovery from the subsurface region may be facilitated based on the total simulated resource availability and uncertainty from the subsurface region and/or other information.

A system for subsurface resource assessment may include one or more electronic storage, one or more processors and/or other components. The electronic storage may store information relating to a subsurface region, subsurface property information, information relating to subsurface properties, information relating to domains, information relating to resource availability and uncertainty, information relating to simulation of resource availability and uncertainty, information relating to total simulated resource availability and uncertainty, information relating to resource recovery, and/or other information.

The processor(s) may be configured by machine-readable instructions. Executing the machine-readable instructions may cause the processor(s) to facilitate subsurface resource assessment. The machine-readable instructions may include one or more computer program components. The computer program components may include one or more of a subsurface property component, a domain component, a simulation component, a combination component, a resource recovery component, and/or other computer program components.

The subsurface property component may be configured to obtain subsurface property information and/or other information. The subsurface property information may characterize values of subsurface properties in a subsurface region as a function of location within the subsurface region. In some implementations, the subsurface properties may include geographic properties, geologic properties, physical properties, fluid properties, and/or other subsurface properties.

The domain component may be configured to divide the subsurface region into domains. The subsurface region may be divided into domains based on distributions of the values of the subsurface properties in the domains and/or other information. In some implementations, different parts of the subsurface region may be divided into the domains using different subsurface properties.

In some implementations, the subsurface region may be divided into domains such that the distributions of the values of the subsurface properties in the domains match one or more predefined types of distributions. In some implementations, the predefined type(s) of distributions may include normal distribution, lognormal distribution, triangular distribution, linear distribution, discrete distribution, and/or other types of distribution.

The simulation component may be configured to perform simulation of resource availability and uncertainty from the domains separately. The simulation of resource availability and uncertainty from the domains may be performed to determine simulated resource availability and uncertainty from individual domains.

In some implementations, the simulated resource availability and uncertainty from individual domains may include resource distribution profiles and ranges of uncertainty associated with the resource distribution profiles.

In some implementations, the simulation of resource availability and uncertainty from the domains may be performed using Monte Carlo simulation. In some implementations, the simulation of resource availability and uncertainty from the domains may be calibrated based on field measurements from the subsurface region and/or other information.

The combination component may be configured to determine total simulated resource availability and uncertainty from the subsurface region. The total simulated resource availability and uncertainty from the subsurface region may be determined based on the combination of the simulated resource availability and uncertainty from the individual domains and/or other information.

In some implementations, the combination of the simulated resource availability and uncertainty from the individual domains may include a weighted combination of the simulated resource availability and uncertainty based on size or significance of the domains.

The resource recovery component may be configured to facilitate resource recovery from the subsurface region. The resource recovery from the subsurface region may be facilitated based on the total simulated resource availability and uncertainty from the subsurface region and/or other information.

In some implementations, facilitation of the resource recovery from the subsurface region based on the total simulated resource availability and uncertainty from the subsurface region may include determination of sensitivities of resource availability to different subsurface properties of the subsurface region.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for subsurface resource assessment.

FIG. 2 illustrates an example method for subsurface resource assessment.

FIG. 3A illustrates an example subsurface region and an example distribution of thickness within the subsurface region.

FIG. 3B illustrates examples domains within a subsurface region and example distributions of thickness within the domains.

FIG. 3C illustrates examples domains within a subsurface region.

FIG. 4 illustrates examples of input and output of simulation of multiple domains for subsurface resource assessment.

FIG. 5 illustrates examples of subsurface resource assessment.

FIG. 6 illustrates an example tornado diagram.

### DETAILED DESCRIPTION

The present disclosure relates to subsurface resource assessment. A subsurface region is divided into multiple domains based on criteria defined to better represent the input data and uncertainty distribution. Resource availability is simulated independently at the domain scale and then combined to assess the overall resource availability and uncertainty from the entire subsurface region. The overall resource availability and uncertainty are used to facilitate resource recovery from the subsurface region.

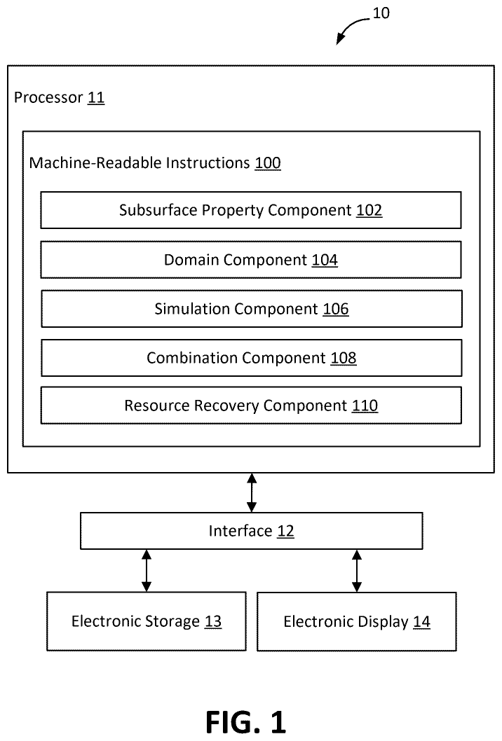

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. This disclosure relates to subsurface resource assessment. Subsurface property information and/or other information may be obtained by the processor 11. The subsurface property information may characterize values of subsurface properties in a subsurface region as a function of location within the subsurface region. The subsurface region may be divided into domains by the processor 11 based on distributions of the values of the subsurface properties in the domains. Simulation of resource availability and uncertainty from the domains may be performed by the processor 11 separately to determine simulated resource availability and uncertainty from individual domains. Total simulated resource availability and uncertainty from the subsurface region may be determined by the processor 11 based on combination of the simulated resource availability and uncertainty from individual domains. Resource recovery from the subsurface region may be facilitated by the processor 11 based on the total simulated resource availability and uncertainty from the subsurface region and/or other information.

The electronic storage 13 may be configured to include one or more electronic storage media that electronically stores information. The electronic storage 13 may store software algorithms, information determined by the processor 11, information received remotely, and/or other information that enables the system 10 to function properly. For example, the electronic storage 13 may store information relating to a subsurface region, subsurface property information, information relating to subsurface properties, information relating to domains, information relating to resource availability and uncertainty, information relating to simulation of resource availability and uncertainty, information relating to total simulated resource availability and uncertainty, information relating to resource recovery, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a subsurface region, subsurface property information, information relating to subsurface properties, information relating to domains, information relating to resource availability and uncertainty, information relating to simulation of resource availability and uncertainty, information relating to total simulated resource availability and uncertainty, information relating to resource recovery, and/or other information.

Resource estimation for a subsurface region includes determination of available resource in the subsurface region as well as uncertainty associated with the resource availability. Deterministic approaches for resource estimation does not account for variations of resource availability and does not provide information on uncertainty associated with resource availability. Simple stochastic approaches for resource estimation fails to account for realistic variations of subsurface properties in the subsurface region and associated uncertainty. Popular types of distributions used in stochastic approaches for resource estimation does not match the realistic distributions of subsurface properties within a subsurface region, and large errors and uncertainties are introduced via use of such types of distributions to represent input distribution for computation of resource availability and associated uncertainty.

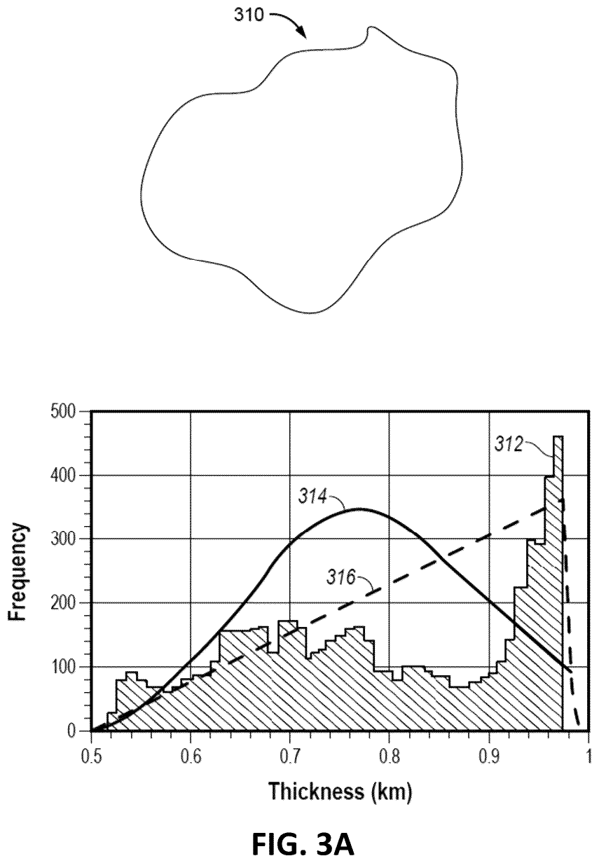

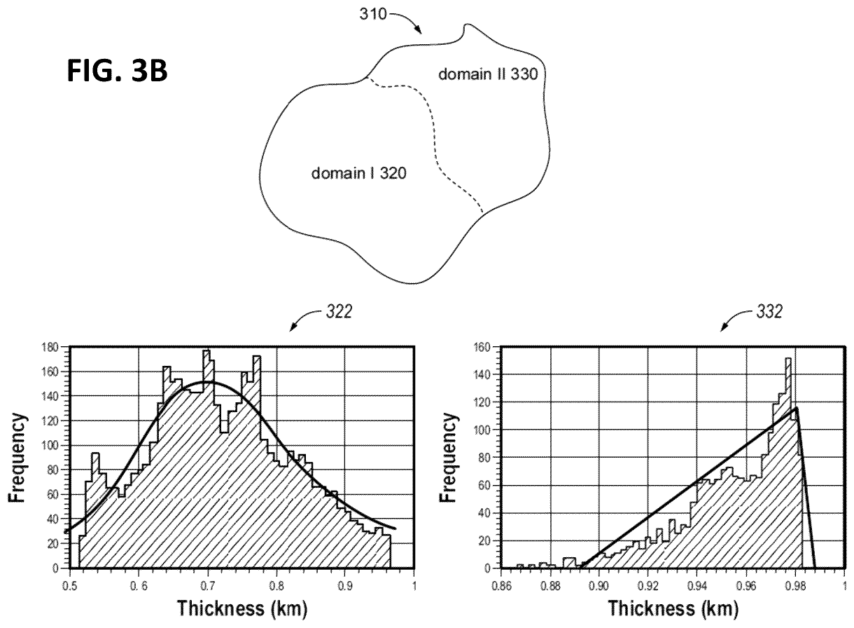

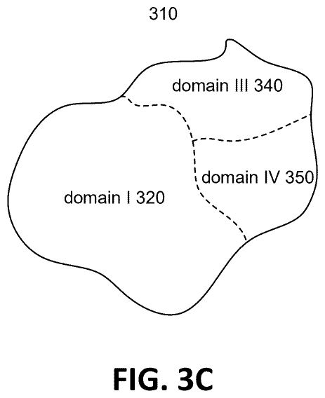

For example, FIG. 3A illustrates an example subsurface region 310 and an example thickness distribution 312 within the subsurface region 310. While FIG. 3A shows the subsurface region 310 in two-dimensions, this is merely as an example and is not meant to be limiting. A subsurface region be defined in three-dimensions and/or other dimensions. A domain within a subsurface region may include a part (e.g., a two-dimensional part, a three-dimensional part, other-dimensional part) of the subsurface region.

As shown in FIG. 3A, the shape of the thickness distribution 312 within the subsurface region 310 does not match the shape of a log normal distribution 314 or the shape of a triangular distribution 316. There is a mismatch between the shape of the thickness distribution 312 within the subsurface region 310 and the shapes of the log normal and triangular distributions 314, 316. The log normal and triangular distributions 314, 316 do not meaningfully represent the thickness distribution 312 within the subsurface region 310.

Use of either the log normal distribution 314 or the triangular distribution 316 to represent the variations in thickness within the subsurface region 310 to determine resource availability and associated uncertainty within the subsurface region 310 would result in both inaccurate estimation of resource (e.g., geothermal resource) available within the subsurface region 310 and inaccurate determination uncertainty associated with the estimated resource availability.

The present disclosure provides a multi-domain scheme to more accurately determine both resource availability within a subsurface region and uncertainty associated with the resource availability. In the multi-domain scheme, a subsurface region is divided into multiple domains for independent simulation of resource availability and uncertainty. The subsurface region in divided into multiple domains based on distributions of subsurface properties within the subsurface region. The subsurface region is divided so that individual domains include distributions of subsurface properties that are meaningfully represented by certain types of distributions (normal distribution, lognormal distribution, triangular distribution, linear distribution, discrete distribution). The subsurface region is divided so that the shapes of the distributions of subsurface properties within the individual domains match the shapes of certain types of distributions. Such division of the subsurface region ensures that the input data distributions for simulation of resource availability and uncertainty are meaningfully represented/matches the popular types of distributions used in stochastic approaches for resource estimation. Such division of the subsurface region result in more accurate assessment of resource availability and uncertainty in the subsurface region. The resource availability and associated uncertainty are simulated within individual domains separately, and the simulated resource availability and associated uncertainty from individual domains are combined to determine the total simulated resource availability and associated uncertainty from the subsurface region. Combining the simulation results of individual domains forms a combined distribution of the overall outcome of the entire subsurface region.

For example, FIG. 3B shows the subsurface region 310 divided into two domains: domain I 320, domain II 330. The subsurface region 310 is divided based on the distribution of thickness within the subsurface region such that the domain I 320 includes a thickness distribution 322 and the domain II 330 includes a thickness distribution 332. The shape of the thickness distribution 322 in the domain I 320 matches the shape of a log normal distribution and the shape of the thickness distribution 332 in the domain II 330 matches the shape of a triangular distribution. The log normal distribution is assigned as the input data distribution for simulation of resource availability and uncertainty within the domain I 320, and the triangular distribution is assigned as the input distribution for simulation of resource availability and uncertainty within the domain II 330. Such division of a subsurface region into domains and such assignment of distributions for simulation of resource availability and uncertainty improves the input distribution accuracy/granularity and improve the accuracy of resource availability and uncertainty assessment.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate subsurface resource assessment. The machine-readable instructions 100 may include one or more computer program components. The machine-readable instructions 100 may include one or more of a subsurface property component 102, a domain component 104, a simulation component 106, a combination component 108, a resource recovery component 110, and/or other computer program components.

The subsurface property component 102 may be configured to obtain subsurface property information and/or other information. Obtaining subsurface property information may include one or more of accessing, acquiring, analyzing, determining, developing, examining, generating, identifying, loading, locating, measuring, opening, preparing, receiving, retrieving, reviewing, selecting, storing, and/or otherwise obtaining the subsurface property information. The subsurface property component 102 may obtain subsurface property information from one or more locations. For example, the subsurface property component 102 may obtain subsurface property information from a storage location, such as the electronic storage 13, electronic storage of a device accessible via a network, and/or other locations. The subsurface property component 102 may obtain subsurface property information from one or more hardware components (e.g., a computing device, a sensor) and/or one or more software components (e.g., software running on a computing device). The subsurface property component 102 may obtain subsurface property information from one or more users. Subsurface property information may be stored within a single file or multiple files.

The subsurface property information may characterize values of subsurface properties in a subsurface region. A subsurface region may refer to a part of earth located beneath the surface/located underground. A subsurface region may refer to a part of earth that is not exposed at the surface. A subsurface region may be defined in a single dimension (e.g., a point, a line) or in multiple dimensions (e.g., a surface, a volume). A subsurface region may include geothermal resources, such as hot water and/or other fluids found at various depths and temperatures and/or stable temperature of the subsurface. A subsurface region may include other types of resources.

The subsurface property information may characterize values of subsurface properties in a subsurface region as a function of location (e.g., latitude, longitude, depth) within the subsurface region. The subsurface property information may characterize values of subsurface properties in different locations within a subsurface region. The subsurface property information may characterize values of subsurface properties over ranges of locations (e.g., area, volume).

The subsurface property information may be generated based on surveys of the subsurface region. For example, the subsurface property information may be generated based on samples from exploratory wells, seismic survey, geothermal energy survey, and/or other types of surveys of the subsurface region.

The subsurface property information may characterize values of subsurface properties in a subsurface region by including information that defines, delineates, describes, identifies, is associated with, quantifies, reflects, sets forth, and/or otherwise characterizes the values of subsurface properties in the subsurface region. The subsurface property information may directly and/or indirectly characterize values of subsurface properties in a subsurface region. For example, the subsurface property information may characterize values of subsurface properties in a subsurface region by including information that specifies the values of the subsurface properties and/or information from which the values of the subsurface properties may be determined. The subsurface property information may characterize values of subsurface properties in a subsurface region by including information that specifies the types of the subsurface properties and/or information from which the types of the subsurface properties may be determined. Other types of subsurface property information are contemplated.

A subsurface property may refer to attribute, quality, and/or characteristics of a subsurface region. A subsurface property may refer to physical arrangement of materials (e.g., subsurface elements) within a subsurface region. A subsurface property may refer to property (e.g., attribute, characteristic, quality, trait) of materials in a subsurface region. Examples of subsurface properties may include geographic properties, geologic properties, physical properties, fluid properties, and/or other subsurface properties. Geographic properties may refer to properties relating to man-made locations (e.g., boundaries between areas, such as countries or cities) and/or natural locations relating to a subsurface region. Geologic properties may refer to properties relating to physical structure and/or subsurface element within a subsurface region. Physical properties may refer to properties relating to materials within the substance. Fluid properties may refer to properties relating to fluid within a subsurface region. For instance, subsurface properties may include thickness, gross rock volume, rock type, geo-structures, porosity, fluid phases, fluid density, fluid heat capacity, matrix density, matrix heat capacity, geothermal gradient, heat flows, and/or temperature (e.g., initial temperature, final temperature) of a subsurface region. Other types of subsurface properties are contemplated.

The domain component 104 may be configured to divide the subsurface region into multiple domains. Individual domains may include a part of the subsurface region. A domain be defined in three-dimensions and/or other dimensions. Dividing the subsurface region into domains may include separating the subsurface region into the domains. The subsurface region may be divided into domains based on subsurface properties and/or other information. The subsurface region may be divided into domains based on values of subsurface properties and/or other information. The subsurface region may be divided into domains based on distributions of values of subsurface properties in the domains and/or other information.

The subsurface region may be divided such that the distributions of values of subsurface properties in the domains match one or more predefined types of distributions. For example, the subsurface region may be divided such that the distributions of values of subsurface properties in the domains match normal distribution, lognormal distribution, triangular distribution, linear distribution, discrete distribution, and/or other types of distribution. The subsurface region may be divided into domains that include better-confined input distributions for simulation of resource availability and uncertainty. The subsurface region may be divided into domains such that the input distributions used for simulation of resource availability and uncertainty are more accurate/representative of the subsurface properties and uncertainty within the domains. Rather than using a single input distribution that groups together large amounts of subsurface property variations within the subsurface region, the subsurface region may be divided into multiple domains with multiple input distributions that provide more accurate/granular representations of the subsurface properties and uncertainties within individual domains.

A distribution of subsurface property in a domain matching a particular type of distribution may include the distribution of subsurface property in the domain being meaningfully represented/characterized by the particular type of distribution. A distribution of subsurface property in a domain matching a particular type of distribution may include the shape of the distribution of subsurface property in the domain matching the shape of the particular type of distribution. A distribution of subsurface property in a domain matching a particular type of distribution may include the difference between the distribution of subsurface property and the particular type of distribution being less than a threshold amount. The domains may be assigned with the particular type of distribution (e.g., normal distribution, lognormal distribution, triangular distribution, linear distribution, discrete distribution) that matches the distributions of subsurface property in the domains. The domains may be assigned with distribution type(s) for individual subsurface properties (e.g., thickness, gross rock volume, rock type, geo-structures, porosity, fluid phases, fluid density, fluid heat capacity, matrix density, matrix heat capacity, geothermal gradient, heat flows, temperature).

For example, FIG. 3B shows an example division of the subsurface region 310 into domain I 320 and domain II 330, with the domain I 320 including input distribution for thickness in the shape of a log normal distribution and the domain II 330 including input distribution for thickness in the shape of a triangular distribution. The thickness for the domain I 320 may be assigned with the log normal distribution and the thickness for the domain II 330 may be assigned with the triangular distribution.

In some implementations, different parts of the subsurface region may be divided into the domains using different subsurface properties. For example, different parts of the subsurface region may be divided using differences in thickness, gross rock volume, rock type, geo-structures, porosity, fluid phases, fluid density, fluid heat capacity, matrix density, matrix heat capacity, geothermal gradient, heat flows, and/or temperature of the subsurface region. The subsurface region may be divided to group together areas/volumes with similar subsurface properties.

For example, the subsurface region may be divided such that geographic areas or rock volumes in different geologic strata/geobodies are in different domains. The subsurface region may be divided such that a geological zone with steam as the dominant reservoir fluid phase are separate from a geological zone with water as the dominant reservoir fluid phase. The subsurface region may be divided such that geological zones with different heat capacity are in different domains. A domain may be further divided into smaller domains, and individual domains may be treated independently of each other for simulation of resource availability and uncertainty. An example formula for dividing a subsurface region into multiple domains is provided below, with k denoting the kth domain and n being the total number of domains. Use of other formulas is contemplated.

$$Q = {\sum }_{k = 1}^{n} ( Rock Area * Rock Thickness * ( Initial Temperature - Final Temperature ) * {( Rock Matrix Density * Rock Matrix Heat Capacity * ( 1. - Porosity ) + Fluid Density * Fluid Heat Capacity * Porosity )}_{k}$$

For example, in FIG. 3C, the subsurface region 310 may be divided into three domains 320, 340, 350. The subsurface region 310 may be initially divided into two domains, as shown in FIG. 3B. The domain II 330 (shown in FIG. 3B) may be further divided into the domain III 340 and the domain IV 350. The domains 340, 350 may be created by using subsurface properties other than thickness (which was used to create domains 320, 330). For example, the domains 340, 350 may be created based on the heterogeneity in the domain II 330. Simulation of resource availability and uncertainty may be performed separately for the domain I 320, the domain III 340, and the domain IV 350, and the results may be combined to determine total resource availability and uncertainty within the subsurface region 310.

As another example, a subsurface region may include four zones with different thermal gradients. Dividing the subsurface region into four domains for the different thermal gradients may make the thermal gradient distributions more accurate for individual domains. One of the domains may include both steam and water as the fluid phase in the pore spaces. This domains may be further divided into different domains for steam and water, resulting in the subsurface region being divided into five domains. Other divisions of a subsurface region are contemplated.

The simulation component 106 may be configured to perform simulation of resource availability and uncertainty from the domains separately. Simulation of resource availability and uncertainty from a domain may be performed independently of other domains. Simulation of resource availability and uncertainty from the domains may be performed separately to determine simulated resource availability and uncertainty from individual domains. The simulation component 106 may simulate the type and/or the amount of resource available within a domain and quantify the amount and/or range of uncertainty for the type and/or the amount of available resource simulated within the domain. Outputs/simulated results from individual domains may be reviewed independently (e.g., in tables and/or graphs).

Resource availability in a domain may refer to estimation of available resource in the domain. Resource in a domain/subsurface region may refer to usable asset in the domain/subsurface region. For example, resource in a domain/subsurface region may include geothermal resource (e.g., total heat resource, heat resource density, temperature difference, matrix volume, fluid volume, heat from matrix, heat from fluid, efficiency) in the domain/subsurface region. Other types of resource are contemplated. Uncertainty of resource availability may refer to doubt about the resource availability. Uncertainty of resource availability may be quantified using amount (e.g., confidence) and/or range (e.g., interval).

Simulation of resource availability and uncertainty from a domain may include modeling types and/or amounts of resource available in the domain based on different values of subsurface properties. Simulation of resource availability and uncertainty from a domain may include generation of one or more computer models for the domain to simulate the types and/or amounts of resource available in the domain based on different values of subsurface properties. The input distributions of subsurface properties for a domain may be used to perform numerous simulations of resource availability and uncertainty from the domain. For example, hundreds or thousands of possible scenarios of resource availability and uncertainty may be output by the simulation.

In some implementations, the simulation of resource availability and uncertainty from the domains may be performed using Monte Carlo simulation. The Monte Carlo simulation may build a model of possible resource availability and uncertainty using the input distributions of subsurface properties for the domain. The possible resource availability and uncertainty may be computed numerous times using different sets of randomly sampled subsurface property values, with the sampling of subsurface property values limited by the input distributions for the domain. Use of other types of simulations is contemplated.

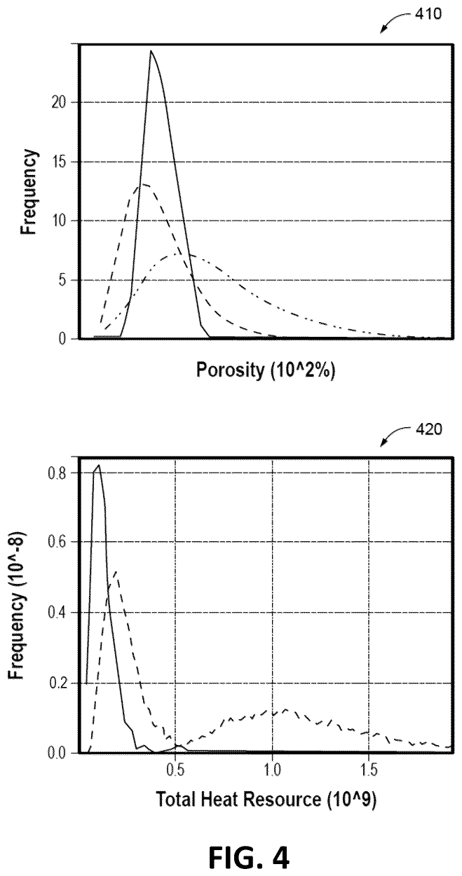

FIG. 4 illustrates examples of input 410 and output 420 of simulation of multiple domains for subsurface resource assessment. The input 410 may include input distributions of porosity for three different domains. The input distributions may show the frequency with which different values of porosity are present within different domains. The output 420 may include output distributions of total heat resource within three different domains. The output distributions may show the frequency with which different values of heat resource are simulated within different domains.

In some implementations, the simulated resource availability and uncertainty from individual domains may include resource distribution profiles and ranges of uncertainty associated with the resource distribution profiles. Different resource distribution profiles may be associated with different ranges of uncertainty.

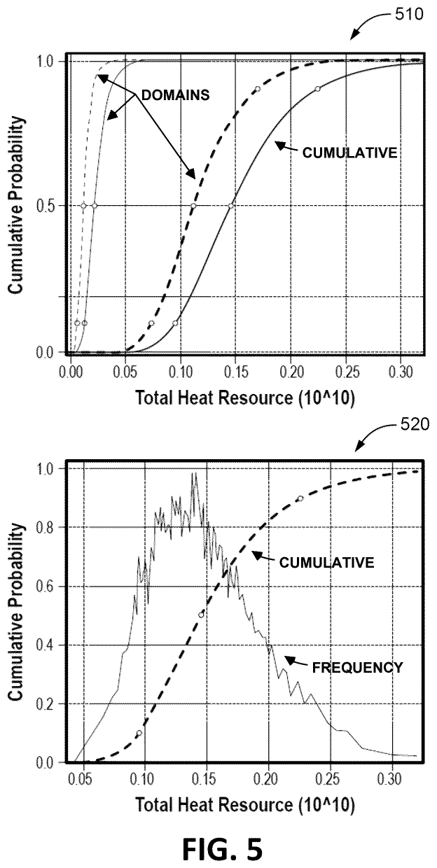

FIG. 5 illustrates examples of subsurface resource assessment. FIG. 5 may include a view 510 of total heat resource simulated within three different domains and the subsurface region, along with the probabilities for the simulated amounts.

In some implementations, the simulation of resource availability and uncertainty from the domains may be calibrated based on field measurements from the subsurface region and/or other information. Samples/measurements taken from the subsurface region may be compared with outputs of the simulation to calibrate the simulation. The simulation of resource availability and uncertainty from the domains may be calibrated to better match the samples/measurements taken from the subsurface region. Calibration of the simulation may improve the accuracy of the simulated resource availability output by the simulation, as well as the uncertainty of the simulated resource availability (e.g., increase the accuracy of the mean/P50 value, narrow the ranges of uncertainty).

The combination component 108 may be configured to determine total simulated resource availability and uncertainty from the subsurface region. The total simulated resource availability and uncertainty from the subsurface region may be determined based on the combination of the simulated resource availability and uncertainty from the individual domains and/or other information. The simulated resource availability and associated uncertainty from different domains may be combined to determine the total simulated resource availability and uncertainty from the subsurface region. For example, results/discrete distributions from Monte Carlo simulations may be merged to provide both resource distribution for the entire subsurface region, along with combined uncertainty ranges.

The output of resource distributions simulated from different domains may be combined with determine a cumulative distribution of resource from the subsurface region. The cumulative distribution of resource from the subsurface region may be associated with a range of uncertainty, which may be an important factor in resource potential and risk analysis for the subsurface region. The cumulative distribution of resource and associated uncertainty obtained from the multi-domain scheme of the present disclosure may be more accurate/representative than distribution of resource and uncertainty obtained without dividing the subsurface region into multiple domains. The cumulative distribution of resource and associated uncertainty may provide/enable more accurate evaluation of the resources in the subsurface region.

In some implementations, the combination of the simulated resource availability and uncertainty from the individual domains may include a weighted combination of the simulated resource availability and uncertainty based on size or significance of the domains. Size of a domain may refer to the relative extent of the domain (e.g., area, volume). Significance of a domain may refer to the relative importance of the domain to resource availability/usage (e.g., density, porosity, ease of access). For example, the simulated resource availability and uncertainty from a larger domain may have more impact on the combination than the simulated resource availability and uncertainty from a smaller domain. As another example, simulated resource availability and uncertainty from a more significant domain (e.g., more dense, more porous, easier/faster/cheaper to access) may have more impact on the combination than the simulated resource availability and uncertainty from a less significant domain (e.g., less dense, less porous, harder/slower/more expensive to access).

Referring to FIG. 5, the view 510 may include a cumulative curve to show the combination of total heat resource simulated within three different domains, along with the probabilities for the simulated amounts. A view 520 may include the cumulative curve, along with a frequency curve to show the frequency of occurrence of different amount of resources within the entire subsurface region.

The resource recovery component 110 may be configured to facilitate resource recovery from the subsurface region. Resource recovery from a subsurface region may include accessing, extracting, storing, transporting, utilizing, and/or otherwise recovering resource from the subsurface region. For example, resource recovery from a subsurface region may include accessing, extracting, storing, transporting, utilizing, and/or otherwise recovering geothermal resource from the subsurface region. Recovery of other types of resources is contemplated. Facilitating resource recovery from a subsurface region may include assisting, automating, carrying out, controlling, designing, enabling, implementing, initiating, performing, planning, scheduling, setting up, and/or otherwise facilitating the resource recovery from the subsurface region. Facilitating resource recovery from a subsurface region may include starting, stopping, changing, preventing, and/or otherwise controlling the resource recovery from the subsurface region.

Facilitating resource recovery from a subsurface region may include providing information about the resource recovery to one or more personnels (e.g., engineers, field operators). For example, information on total simulated recovery from the subsurface region, the associated uncertainty, risk analysis, and/or other information relating to resource recovery may be presented. Facilitating resource recovery from a subsurface region may include recommending how to perform resource recovery. Other facilitations of resource recovery are contemplated.

The resource recovery from the subsurface region may be facilitated based on the total simulated resource availability and uncertainty from the subsurface region and/or other information. For example, the total simulated resource availability and uncertainty from the subsurface region may be used to perform risk analysis for resource recovery the subsurface region, and whether resource recovery will be performed in the subsurface region and/or how the resource recovery will be performed in the subsurface region may be determined based on the results of the risk analysis.

The plan, design, and/or performance of resource recovery may be determined based on the total simulated resource availability and uncertainty from the subsurface region. For instance, location of equipment in the subsurface region (e.g., where to place wells, depths of wells, where to place power plants (e.g., turbine, generator), where to place cooling towers), the type of equipment in the subsurface region, the design of equipment in the subsurface region, the operation parameters of equipment in the subsurface region (e.g., cycles of production) may be determined based on the total simulated resource availability and uncertainty from the subsurface region.

In some implementations, the resource recovery from the subsurface region may be facilitated further based on one or more dynamic engineering parameters. Dynamic engineering parameters may include parameters for operating equipment in the subsurface region for resource recovery. Dynamic parameters may refer to parameters for resource recovery that may change with time and/or performance of resource recovery. For example, drawdown rate and/or recharge rate for the subsurface region may be provided for use in resource recovery.

In some implementations, facilitation of the resource recovery from the subsurface region based on the total simulated resource availability and uncertainty from the subsurface region may include determination of sensitivities of resource availability to different subsurface properties of the subsurface region. Sensitivities of resource availability to different subsurface properties of the subsurface region may be determined based on the results of the simulations. Sensitivity of resource availability to a subsurface property may refer to the impact the subsurface property has on the resource availability and/or associated uncertainty. Sensitivity of resource availability to a subsurface property may refer to the degree with which changes in the subsurface property changes the resource availability and/or associated uncertainty.

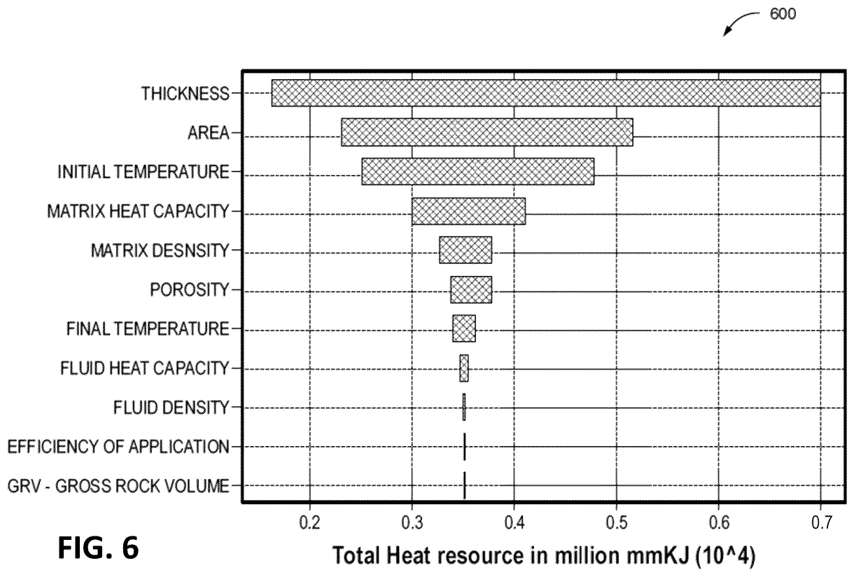

In some implementations, the sensitivities of resource availability to different subsurface properties of the subsurface region may be presented within one or more tornado diagrams. FIG. 6 illustrates an example tornado diagram 600. The tornado diagram 600 may show the impact that different subsurface properties have on the amount of total heat resource in the subsurface region. The tornado diagram 600 may show relative contribution of errors and/or uncertainties from different subsurface properties. Other visual representations of the sensitivities of resource availability to different subsurface properties of the subsurface region are contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a non-transitory, tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

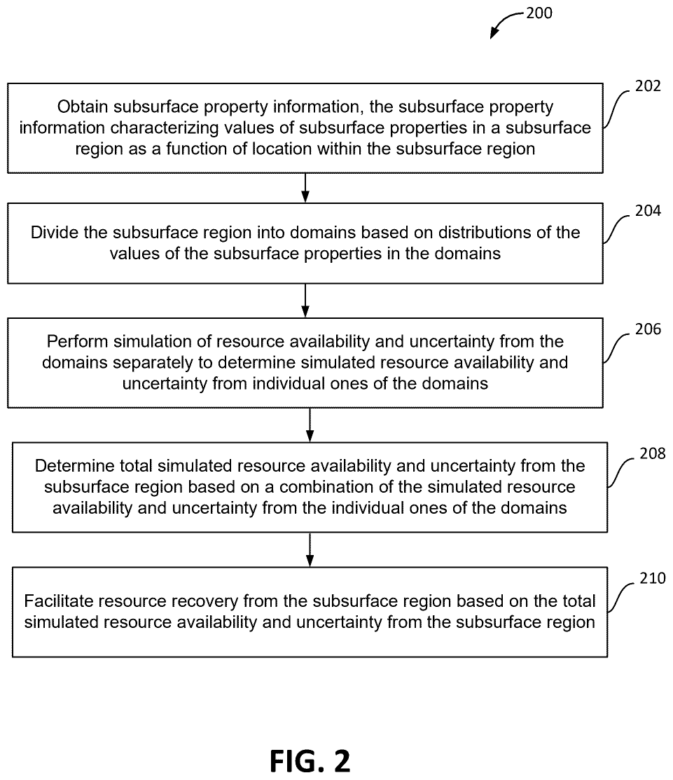

FIG. 2 illustrates a method 200 for subsurface resource assessment. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, subsurface property information is obtained. The subsurface property information characterizes values of subsurface properties in a subsurface region as a function of location within the subsurface region. In some implementations, operation 202 may be performed by a processor component the same as or similar to the subsurface property component 102 (Shown in FIG. 1 and described herein).

At operation 204, the subsurface region is divided into domains based on distributions of the values of the subsurface properties in the domains. In some implementations, operation 204 may be performed by a processor component the same as or similar to the domain component 104 (Shown in FIG. 1 and described herein).

At operation 206, simulation of resource availability and uncertainty from the domains is performed separately to determine simulated resource availability and uncertainty from individual domains. In some implementations, operation 206 may be performed by a processor component the same as or similar to the simulation component 106 (Shown in FIG. 1 and described herein).

At operation 208, total simulated resource availability and uncertainty from the subsurface region is determined based on combination of the simulated resource availability and uncertainty from individual domains. In some implementations, operation 208 may be performed by a processor component the same as or similar to the combination component 108 (Shown in FIG. 1 and described herein).

At operation 210, resource recovery from the subsurface region is facilitated based on the total simulated resource availability and uncertainty from the subsurface region. In some implementations, operation 210 may be performed by a processor component the same as or similar to the resource recovery component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for subsurface resource assessment, the system comprising:
one or more physical processors configured by machine-readable instructions to:
obtain subsurface property information, the subsurface property information characterizing values of subsurface properties in a subsurface region as a function of location within the subsurface region;
divide the subsurface region into domains based on distributions of the values of the subsurface properties in the domains;
perform simulation of resource availability and uncertainty from the domains separately to determine simulated resource availability and uncertainty from individual ones of the domains;
determine total simulated resource availability and uncertainty from the subsurface region based on a combination of the simulated resource availability and uncertainty from the individual ones of the domains; and
facilitate resource recovery from the subsurface region based on the total simulated resource availability and uncertainty from the subsurface region.

2. The system of claim 1, wherein the simulated resource availability and uncertainty from the individual ones of the domains include resource distribution profiles and ranges of uncertainty associated with the resource distribution profiles.

3. The system of claim 1, wherein the subsurface properties include geographic properties, geologic properties, physical properties, and/or fluid properties.

4. The system of claim 1, wherein different parts of the subsurface region are divided into the domains using different subsurface properties.

5. The system of claim 1, wherein the subsurface region is divided into the domains such that the distributions of the values of the subsurface properties in the domains match one or more predefined types of distributions.

6. The system of claim 1, wherein the one or more predefined types of distributions include normal distribution, lognormal distribution, triangular distribution, linear distribution, and/or discrete distribution.

7. The system of claim 1, wherein the combination of the simulated resource availability and uncertainty from the individual ones of the domains includes a weighted combination of the simulated resource availability and uncertainty based on size or significance of the domains.

8. The system of claim 1, wherein the simulation of resource availability and uncertainty from the domains is calibrated based on field measurements from the subsurface region.

9. The system of claim 1, wherein the simulation of resource availability and uncertainty from the domains is performed using Monte Carlo simulation.

10. The system of claim 1, wherein facilitation of the resource recovery from the subsurface region based on the total simulated resource availability and uncertainty from the subsurface region includes determination of sensitivities of resource availability to different subsurface properties of the subsurface region.

11. A method for subsurface resource assessment, the method comprising:
obtaining subsurface property information, the subsurface property information characterizing values of subsurface properties in a subsurface region as a function of location within the subsurface region;
dividing the subsurface region into domains based on distributions of the values of the subsurface properties in the domains;
performing simulation of resource availability and uncertainty from the domains separately to determine simulated resource availability and uncertainty from individual ones of the domains;
determining total simulated resource availability and uncertainty from the subsurface region based on a combination of the simulated resource availability and uncertainty from the individual ones of the domains; and
facilitating resource recovery from the subsurface region based on the total simulated resource availability and uncertainty from the subsurface region.

12. The method of claim 11, wherein the simulated resource availability and uncertainty from the individual ones of the domains include resource distribution profiles and ranges of uncertainty associated with the resource distribution profiles.

13. The method of claim 11, wherein the subsurface properties include geographic properties, geologic properties, and fluid properties.

14. The method of claim 11, wherein different parts of the subsurface region are divided into the domains using different subsurface properties.

15. The method of claim 11, wherein the subsurface region is divided into the domains such that the distributions of the values of the subsurface properties in the domains match one or more predefined types of distributions.

16. The method of claim 11, wherein the one or more predefined types of distributions include normal distribution, lognormal distribution, triangular distribution, linear distribution, and/or discrete distribution.

17. The method of claim 11, wherein the combination of the simulated resource availability and uncertainty from the individual ones of the domains includes a weighted combination of the simulated resource availability and uncertainty based on size or significance of the domains.

18. The method of claim 11, wherein the simulation of resource availability and uncertainty from the domains is calibrated based on field measurements from the subsurface region.

19. The method of claim 11, wherein the simulation of resource availability and uncertainty from the domains is performed using Monte Carlo simulation.

20. The method of claim 11, wherein facilitating the resource recovery from the subsurface region based on the total simulated resource availability and uncertainty from the subsurface region includes determining sensitivities of resource availability to different subsurface properties of the subsurface region.
